(19) United States
(12) Patent Application Publication
(10) Pub. No.: US 2012/0325709 A1
(43) Pub. Date: Dec. 27, 2012

(54) CARBON DIOXIDE INDICATOR USING CHITOSAN AND FOOD PACKAGE COMPRISING THE SAME

(75) Inventors: Sanghoon Ko, Seoul (KR); Junho Jung, Seoul (KR); Seung Ju Lee, Seoul (KR)

(73) Assignee: Dongguk University Industry-Academic Cooperation Foundation, Seoul (KR)

(21) Appl. No.: 13/367,878

(22) Filed: Feb. 7, 2012

(30) Foreign Application Priority Data
Jun. 21, 2011 (KR) 10-2011-0060362

(51) Int. Cl. B65D 85/00; G01D 21/00

(52) U.S. Cl. 206/459.1; 116/206

(57) ABSTRACT

Disclosed is a carbon dioxide indicator using chitosan and a food package comprising the same. The carbon dioxide indicator senses variation in partial pressure of carbon dioxide present in a head space of the package and thus visibly displays the result. The carbon dioxide indicator rapidly reacts at a specific critical point (pH 7.0) or less, thus being considerably highly sensitive.

### CROSS-REFERENCE TO RELATED APPLICATION

The present application claims the benefit of Korean Patent Application No. 10-2011-0060362 filed Jun. 21, 2011, the entire content of which application is incorporated by reference herein.

### BACKGROUND OF THE INVENTION

1. Field of the Invention

The present invention relates to a carbon dioxide indicator and a food package comprising the same. More specifically, the present invention relates to a carbon dioxide indicator using chitosan and a food package comprising the same.

2. Description of the Related Art

The most important quality indicator of food packaging is a partial pressure of carbon dioxide in internal air. For example, in Kimchi, the amount of carbon dioxide generated increases as storage time increases. The generation of carbon dioxide causes packages to swell and causes packages to explode once a certain pressure is reached. As such, the amount (partial pressure) of carbon dioxide in the package depends on storage time and is affected by food type, respiration characteristics, package materials, package size, ratio of head space to food, storage conditions and the like.

Accordingly, there is a greatly increasing need for development of a system or indicator to measure the amount of carbon dioxide present in a head space of foods. A carbon dioxide indicator that induces color change corresponding to concentration variation of carbon dioxide using conventional bromothymol blue and methyl red indicators, which are sensitive to pH change, has been developed. The concentration variation of carbon dioxide in this indicator is sensed by real-time color change and the state of food qualities can be estimated from such information.

However, most carbon dioxide indicators including these indicators have great problems of qualities in terms of sensitivity and reliability. Carbon dioxide indicators are greatly disadvantageous in that indicators react with surrounding environments irrelevant to carbon dioxide and environmental information unrelated thereto is accumulated in the indicators, before indicators were produced and used for food packaging.

### SUMMARY OF THE INVENTION

Therefore, the present invention has been made in view of the above problems, and it is an object of the present invention to provide a novel carbon dioxide indicator that senses variation in partial pressure of carbon dioxide present in a head space in a package and thus visibly displays the result, and a food package comprising the same.

In accordance with an aspect of the present invention, the above and other objects can be accomplished by the provision of a carbon dioxide indicator comprising chitosan.

### BRIEF DESCRIPTION OF THE DRAWINGS

The above and other objects, features and other advantages of the present invention will be more clearly understood from the following detailed description taken in conjunction with the accompanying drawings, in which:

FIG. 1 shows variation in transparency of chitosan-containing aqueous solutions with variation in pH;

FIG. 2 shows pH variation of chitosan-containing aqueous solutions with addition of 2-2-amino-2-methyl-1-propanol (AMP). In FIGS. 2, 0%, 5%, 10% and 20% samples mean samples in which pH variation is measured under conditions that AMP is added in an amount of 0%, 5%, 10% or 20% and carbon dioxide is absent. 0%-CO₂, 5%-CO₂, 10%-CO₂ and 20%-CO₂ samples are samples in which pH variation is measured under conditions that AMP is added in an amount of 0%, 5%, 10% or 20% and 100% of carbon dioxide is present.

FIG. 3 shows variation in transparency of chitosan-containing aqueous solution with addition of 2-2-amino-2-methyl-1-propanol(2-amino-2-methyl-1-propanol; AMP). FIGS. 3, 0%, 5%, 10% and 20% samples mean samples in which pH variation is measured under conditions that AMP is added in an amount of 0%, 5%, 10% or 20% and carbon dioxide is absent. 0%-CO₂, 5%-CO₂, 10%-CO₂ and 20%-CO₂ samples are samples in which pH variation is measured under conditions that AMP is added in an amount of 0%, 5%, 10% or 20% and 100% of carbon dioxide is present.

### DETAILED DESCRIPTION OF THE INVENTION

Hereinafter, the present invention will be described in detail.

The present invention provides an indicator that enables carbon dioxide generated during transport and storage of packaged foods to be observed by the naked eye display, and, in particular, an indicator that enables real-time evaluation of food quality during storage and transport based on change in turbidity of an aqueous solution containing chitosan.

In general, chitosan is not well soluble in a neutral aqueous solution, but is soluble under week acidic conditions. For this reason, storage state of foods can be observed by the naked eye using a phenomenon in which chitosan is dissolved and turbidity of aqueous solution is thus varied due to decrease in pH of aqueous solution caused by carbon dioxide during storage and transport of foods.

Carbon dioxide is dissolved in water to produce carbonic acid, which is dissociated into an ionic state and, at this time, hydrogen molecules are released therefrom. As a result, hydrogen ion concentration in the aqueous solution increases and pH of the aqueous solution decreases. Chitosan is insoluble in a neutral aqueous solution, but is dissolved under week acidic conditions and thus becomes transparent.

According to the present invention, when carbon dioxide is generated in packaged foods, partial pressure of carbon dioxide increases and carbon dioxide is dissolved in an indicator containing chitosan. When carbon dioxide is dissolved, pH of the indicator decreases and chitosan contained in the indicator is dissolved and the indicator becomes transparent. At this time, variation of foods quality in the package can be seen by observing the degree to which the indicator has changed from opaque to transparent with the naked eye.

Meanwhile, preferably, the carbon dioxide indicator of the present invention further contains a pigment since addition of the pigment improves visibility. That is, when a pigment is added, turbidity of a chitosan solution changes from opaque to transparent, visibility of added pigment is changed and the effect on increase in visibility occurs, as compared to a simple change of transparency/opaqueness.

Meanwhile, the carbon dioxide indicator of the present invention preferably has an outer surface made of a semi-permeable membrane material that permeates air and does not permeate a liquid. The reason for this is that the membrane absorbs only carbon dioxide generated from foods and prevents the contained chitosan solution from being incorporated in the foods. At this time, the outer surface of the semi-permeable material is preferably a transparent material, enabling variation in internal state to be clearly observed. The reason for this is that when the transparent material is used, visibility can be improved.

Meanwhile, the present invention provides a food package comprising the carbon dioxide indicator according to the present invention. At this time, preferably, the carbon dioxide indicator is provided in a transparent state on an inner surface of the package, to enable the internal state to be readily seen from the outside. The reason for this is that, when the carbon dioxide indicator is provided in a transparent state on the inner surface of the package such that the indicator can be seen from the outside, a consumer can readily find the position thereof and can easily observe changes in the indicator.

Meanwhile, the food to which the present invention is applicable is preferably a food that generates carbon dioxide during storage since the storage state inside the food can be directly seen from the outside by measuring variation of carbon dioxide.

Hereinafter, the following examples will be provided for a further understanding of the invention. The scope of the present invention is not limited to the following examples and includes technical spirits equivalent thereto.

### Example 1

### Observation of Variation in Solubility of Chitosan with Variation in pH

In order to evaluate solubility of chitosan at respective pH values, 10 mg of chitosan was thoroughly dissolved in 1 mL of 0.1 M HCl. Then, pH was adjusted to 2, 3, 4, 5, 6, 7, 8 and 9 with HCl and NaOH, and total volume was adjusted to 5 mL using distilled water. The transmittance of the prepared aqueous chitosan solution was measured at a wavelength of 600 nm using a spectrophotometer.

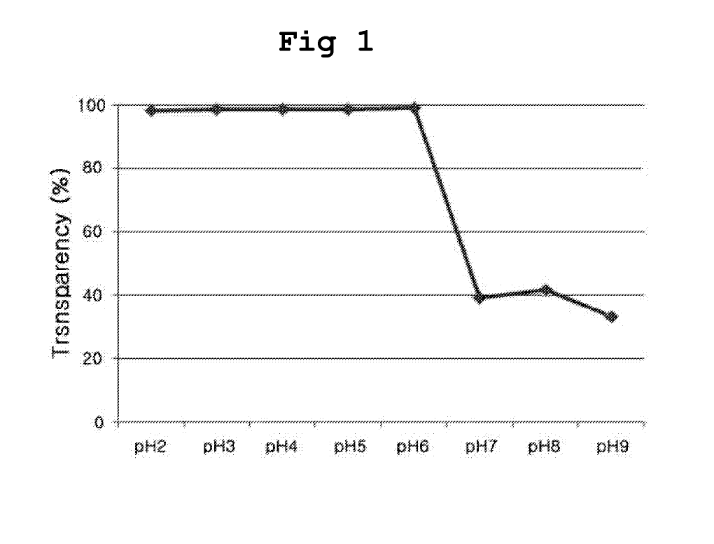

A pH range in which chitosan is dissolved can be seen through the measurement of solubility of chitosan at respective pH values, as shown in FIG. 1. The aqueous chitosan solution was a white aqueous solution to an extent that it had a transmittance of about 40% at pH 7 or more, but chitosan was completely dissolved at a decreased pH of 6 or less and had a transparent state with a transmittance of about 100%.

From these results, it can be seen that chitosan is greatly sensitive to pH and is completely dissolved and changes from opaque to transparent when pH is decreased to 7 or less. This means that chitosan can be used as an indicator based on variation in transparency.

### Example 2

### Confirmation of Transmittance of Aqueous Chitosan Solution and pH Variation Under Carbon Dioxide Storage Conditions

In this example, variations in pH and transmittance of aqueous chitosan solution were evaluated under carbon dioxide storage conditions. For the purpose, whether or not the present invention acts as an indicator was confirmed by adding different concentrations of AMP to an aqueous solution. AMP was 2-2-amino-2-methyl-1-propanol known as a material that absorbs carbon dioxide. At this time, as a control group, a sample in which carbon dioxide was absent was prepared.

First, 10 mg of chitosan was completely dissolved in 1 mL of 0.1 M HCl. Then, AMP was added at different ratios of 0, 5, 10 and 20% (w/v) to the aqueous chitosan solution and pH was adjusted to 7. Distilled water was added to each sample such that total volume was adjusted to 5 mL, pH was finely adjusted to 7 again, the resulting solution was stored under 100% carbon dioxide conditions and variations of pH and transmittance were measured at an interval of 20 minutes.

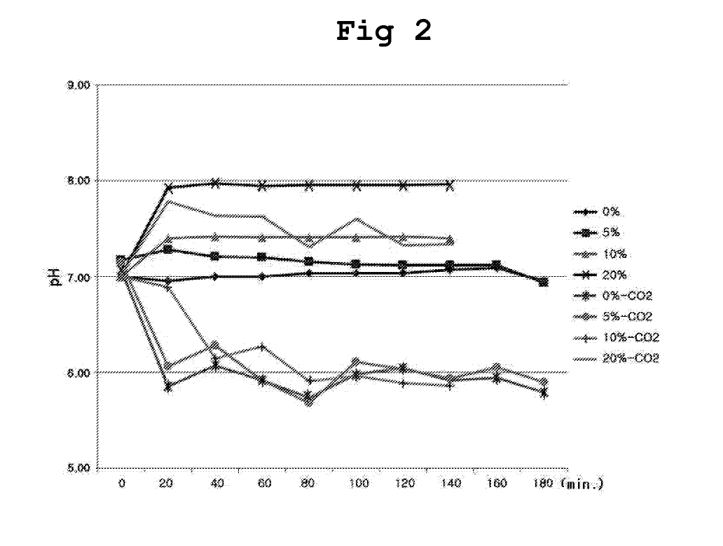

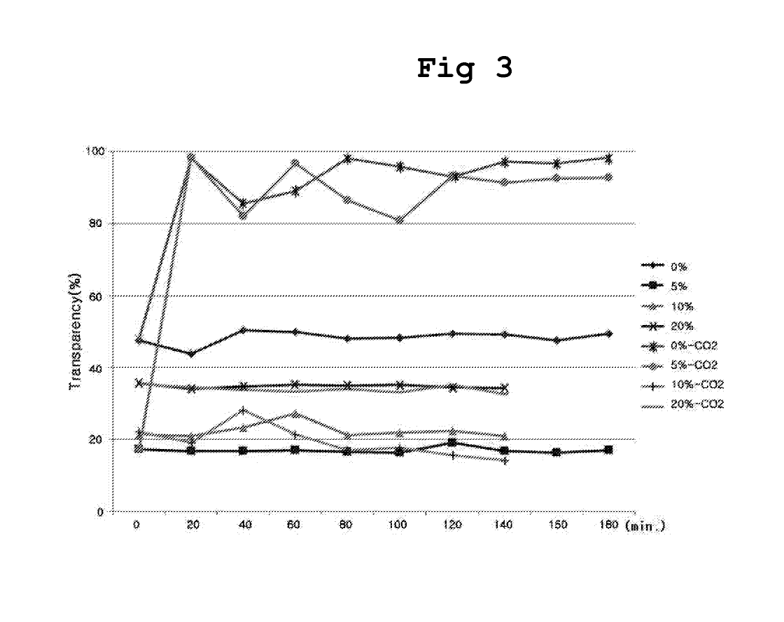

As a result of these tests, as shown in FIG. 2, pH of the aqueous chitosan solution in which the ratio of AMP is 0, 5 or 10% gradually decreases under the conditions of 100% carbon dioxide. However, the sample in which carbon dioxide was absent and the sample in which AMP was added at a ratio of 20% did not exhibit variation in pH. In addition, as shown in FIG. 3, transmittance of the aqueous chitosan solution was varied only in samples in which the ratio of AMP is 0% or 5% under conditions of 100% carbon dioxide and the aqueous solutions was transparent.

Carbon dioxide in the air was absorbed in water and transformed into carbonate ions, which dissociated H+ ions and reduced pH of the solution. When carbon dioxide was not present, the pH of the solution was not decreased and turbidity of chitosan-containing aqueous solution was not changed. In addition, although carbon dioxide was present, if excess AMP was added, the entirety of carbon dioxide absorbed in water reacted with AMP. As a result, the pH of the solution was not decreased, chitosan was not dissolved and turbidity of the aqueous solution was not varied.

In this test, it was confirmed that the sample to which carbon dioxide was not added and the 20%-CO₂ sample to which excess AMP was added under conditions of 100% carbon dioxide did not exhibit decrease in pH and variation in transparency. This result demonstrates that the decrease in pH and variation in transparency of the aqueous solution are caused by dissolution of carbon dioxide in the air in the aqueous solution.

These results of the present invention thus obtained demonstrate that the chitosan indicator of the present invention is also applicable to actual food package models.

As apparent from the above description, the carbon dioxide indicator according to the present invention that can detect variation in carbon dioxide concentration, one index of quality variation in packaged foods, using chitosan, advantageously senses variation in partial pressure of carbon dioxide present in a head space in a package and thus visibly displays the result.

The carbon dioxide indicator using chitosan according to the present invention rapidly reacts at a specific critical point (pH 7.0) or less, thus advantageously having considerably high sensitivity.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A carbon dioxide indicator comprising chitosan.

2. The carbon dioxide indicator according to claim 1, wherein the carbon dioxide indicator reacts with chitosan and becomes transparent, when the carbon dioxide indicator absorbs carbon dioxide.

3. The carbon dioxide indicator according to claim 1, further comprising a pigment.

4. The carbon dioxide indicator according to claim 3, wherein the carbon dioxide indicator reacts with chitosan and turns transparent, when the carbon dioxide indicator absorbs carbon dioxide.

5. The carbon dioxide indicator according to claim 1 or 3, wherein the carbon dioxide indicator has an outer surface made of a semi-permeable material that permeates air and does not permeate a liquid.

6. The carbon dioxide indicator according to claim 5, wherein the outer surface of the carbon dioxide indicator is made of a transparent material that enables variation in internal state to be clearly seen from the outside.

7. A food package comprising the carbon dioxide indicator according to claim 1.

8. The food package according to claim 7, wherein the carbon dioxide indicator is provided in a transparent state on an inner surface of the package such that the indicator can be readily seen from the outside.

9. The food package according to claim 8, wherein the food is a food that generates carbon dioxide during storage.

10. A food package comprising the carbon dioxide indicator according to claim 3.

11. The food package according to claim 10, wherein the carbon dioxide indicator is provided in a transparent state on an inner surface of the package such that the indicator can be readily seen from the outside.

12. The food package according to claim 11, wherein the food is a food that generates carbon dioxide during storage.
